(19) United States
(12) Patent Application Publication
(10) Pub. No.: US 2021/0219102 A1
(43) Pub. Date: Jul. 15, 2021

(54) DEVICES, SYSTEMS, AND METHODS FOR TRACKING BOTTLED LIQUIDS

(71) Applicant: SommID LLC, Brookline, MA (US)

(72) Inventors: Kyle Gion, Brookline, MA (US); Olivia Katcher, Greenwich, CT (US)

(21) Appl. No.: 17/167,183

(22) Filed: Feb. 4, 2021

Related U.S. Application Data
(63) Continuation of application No. PCT/US19/45261, filed on Aug. 6, 2019.
(60) Provisional application No. 62/715,710, filed on Aug. 7, 2018.

(51) Int. Cl. H04W 4/029; G06K 7/10; H04W 4/80

(52) U.S. Cl. CPC H04W 4/029; H04W 4/80; G06K 7/10297; G06K 7/10099

(57) ABSTRACT

The invention encompasses a tracking label that includes a sensor module, a receiver system, and an energy module, in which the sensor module includes a sensor for collecting a data set, and a data transceiver that receives the data set from the sensor and transmits the data set to the receiver system, wherein the receiver system includes at least one of a storage module and a communications module, wherein the storage module includes a flash storage chip capable of storing the data set, wherein the storage module is further capable of transmitting the data to the communications module, wherein the communications module includes a transmitter adapted for transmitting the data set to a data reader positioned external to the tracking label, and wherein the sensor module and the receiver system are powered by the energy module that comprises a rechargeable battery and a radiofrequency energy harvester, wherein the radiofrequency energy harvester collects energy and transmits it to the rechargeable battery to recharge it periodically. The invention further encompasses systems and methods pertaining to such tracking labels.

### RELATED APPLICATIONS

This application is a continuation of International Application No. PCT/US19/45261, which designated the United States and was filed on Aug. 6, 2019, published in English, which claims the benefit of U.S. Provisional Application Ser. No. 62/715,710 filed Aug. 7, 2018. The entire teachings of the above applications are incorporated herein by reference.

### FIELD OF THE APPLICATION

This application relates to devices, systems, and methods for tracking bottled liquids.

### BACKGROUND

Determining the integrity of bottled liquids that are sealed at the time of their production can present a challenge. Without uncorking or uncapping the bottle, there may be no consistent, objective way to verify the authenticity of its contents. This problem is especially difficult in the wine industry. Counterfeit wines and wine fraud are well known, and techniques exist to demonstrate wine authenticity that are similar to those used in art authentication (“What it takes to Out-sleuth Wine Fraud,” L. Teigue, Wall St. Journal, Apr. 6, 2018). Art authentication techniques as applied to bottled liquids require a high degree of expertise, however, and may be too complex and expensive for routine use in the industry. Even for high-value products, such as rare or expensive wines, the hands-on detective work involved in counterfeit detection may not be adequate. Conventional techniques using tools like jeweler's loupes, measuring tapes, UV lights, and microscopes, are too labor-intensive for large-scale use, and conventional techniques require experts to deploy them, with the possibility of human error. There exists a need in the art, therefore, for ways to confirm the authenticity of a particular bottle of wine, so that distributors or collectors can be sure that they are obtaining the product that they are expecting.

Moreover, especially for high-value wines, purchasers are interested in the condition of the wine. Without being able to sample the product, a distributor or a collector must rely on information about the wine's provenance. Such information, including how it has been preserved and by whom, is an important part of determining its value. While databases or blockchain technologies can keep track of the wine's ownership along with related documentation, this overview of the wine's provenance cannot prove the wine has been kept under proper conditions. Typically, purchasers rely on the reputation of the seller, who in turn relies on the reputation of the distributor, who has close working relationships with the wineries. However, records can be inaccurate or even falsified. Even a carefully-kept log of wine storage conditions can be similarly flawed.

At auction, a wine bottle that has been stored at its winery for its entire life, assumed to be in pristine condition, can fetch 50-100% more than a bottle that has been held by multiple owners and at multiple locations around the world. This reflects the uncertainty about the wine's provenance and condition when its location, ownership, and storage parameters cannot be objectively verified. A need exists in the art, therefore, whereby the provenance of a bottled liquid such as a wine bottle can be tracked, including its storage or maintenance conditions, with the relevant data made available to those involved in commercial dealings pertaining thereto. While the present disclosure addresses these needs as they exist for wine commerce, it would be appreciated by those in the field that analogous needs exist for bottlers, preservers, and purveyors of other fine bottled beverages.

### BRIEF DESCRIPTION OF FIGURES

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram showing an embodiment of a bottle tracking system.

FIG. 2 is a block diagram showing an embodiment of an integrity management system adapted to interface with a tracking label.

### SUMMARY

Disclosed herein are embodiments of a tracking label comprising a sensor module, a receiver system, and an energy module, the sensor module comprising a sensor for collecting a data set, and a data transceiver that receives the data set from the sensor and transmits the data set to the receiver system, wherein the receiver system comprises at least one of a storage module and a communications module, wherein the storage module comprises a flash storage chip capable of storing the data set, wherein the storage module is further capable of transmitting the data to the communications module, wherein the communications module comprises a transmitter adapted for transmitting the data set to a data reader positioned external to the tracking label, and wherein the sensor module and the receiver system are powered by the energy module that comprises a rechargeable battery and a radiofrequency energy harvester, wherein the radiofrequency energy harvester collects energy and transmits it to the rechargeable battery to recharge it periodically. As used herein, the term “data transceiver” refers to the presence of a data transmitter and a data receiver on the tracking label, without requiring their enclosure in a single discrete housing, and without requiring any specific proximity of these two components to each other on the tracking label. In embodiments, the communications module comprises at least one of a real-time locating service transmitter or a tag. In embodiments, the transmitter is selected from the group consisting of a near-field communication antenna, a Bluetooth protocol transmitter, and a non-Bluetooth-based transmitter. In embodiments, the radiofrequency energy harvester collects energy from ambient radio waves, or the radiofrequency energy harvester collects energy from radio waves emitted by a radiofrequency energy transmitter.

Also disclosed herein is a tracking label system, comprising the tracking label as described above, a data reader, and a cloud-based storage system operatively connected to the data reader, wherein the data reader reads a data set produced by the tracking label and the data reader transmits the data set to the cloud-based storage system. In embodiments, the tracking label in the tracking label system comprises a Bluetooth protocol transmitter, and the data reader is a Bluetooth-enabled device. In embodiments, the tracking label in the tracking label system comprises at least one of a real-time locating service transmitter or a tag, wherein the real-time locating service transmitter or the tag interfaces with a real-time locating service adapted for providing information about the location of the tracking label in two-dimensional or three-dimensional space. In embodiments, the real-time locating service interfaces with a security system. In embodiments, the cloud-based storage system further comprises a cloud-based database; the cloud-based database can comprise a digitally distributed ledger network, and the digitally distributed ledger network can comprise a blockchain network. In embodiments, the blockchain network is selected from the group consisting of a private blockchain network, a permissioned blockchain network, and a private permissioned blockchain network.

Further disclosed herein are methods of tracking a parameter pertaining to a wine bottle, comprising gathering a data set comprising the parameter using a tracking label as described above, storing the data set in a storage module incorporated in the tracking label, gathering the data set from the tracking label via a data reader external to the tracking label, and storing the data set in a storage system, wherein the storage system comprises an internet-based storage network. In embodiments, the parameter pertaining to a wine bottle is a temperature parameter. In embodiments, the parameter pertaining to a wine bottle is selected from the group consisting of a location parameter, an ownership parameter, and a possession parameter. In embodiments, the internet-based storage network comprises a blockchain network. The methods disclosed herein can further comprise a step of sending a signal pertaining to the parameter from a Bluetooth-protocol transmitter incorporated in the tracking label to a Bluetooth-enabled data reader, and in further embodiments, the parameter is a location parameter, the signal is a positional signal, and the positional signal is received by a data reader, with the data reader, in embodiments, being networked with a security system. In additional embodiments, these aforesaid methods can further comprise the steps of (i) comparing the positional signal received by the data reader with a preselected range of acceptable positions, and (ii) sending a notification to the security system if the positional signal is not within the preselected range of acceptable positions. In embodiments, the methods of tracking a parameter pertaining to a wine bottle can include an additional step of granting a customer read-only access to the data set via a curated interface with the blockchain network; in embodiments, the blockchain network is a private permissioned blockchain network. In embodiments, the methods of tracking a parameter pertaining to a wine bottle can include an additional step of deleting the data set from the storage module after the step of gathering the data or after the step of storing the data. In embodiments, the methods of tracking a parameter pertaining to a wine bottle can include an additional step of encrypting the data set at any time after the step of gathering the data set.

### DETAILED DESCRIPTION

In embodiments, the tracking system described herein includes one or more tracking labels dimensionally adapted to be applied beneath one or more identifying labels on a bottled beverage, for example a wine bottle. The tracking label or labels contain sensor modules that identify data related to the wine bottle itself, for example its position in space or its exposure to agitation, or its temperature. In more detail, a sensor module can measure temperature data throughout the bottle's lifetime, i.e., throughout bottling, storage, and transit. The temperature module can include a temperature sensor to collect temperature data and a data transmitter to convey the temperature data to a storage module where the data is retained over the useful life of the tracking label. In addition, the stored data can be further conveyed to a communications module, comprising for example a near-field-communications (NFC) antenna allowing such data to be accessed externally by a NFC-enabled device such as a smartphone or a tablet. The NFC-enabled device can transmit data to other data storage arrays, and/or to Internet-based database systems, e.g., a cloud-based database running a blockchain framework such as Hyperledger Fabric or the like. Alternatively, the communications module may employ a communications protocol such as Bluetooth to transmit the data to a Bluetooth-enabled device such as a smartphone, tablet, computer, Bluetooth gateway, or the like, or to transmit the data to a network of Bluetooth-enabled devices to enable position tracking, as described below in more detail.

Advantageously, the data collected by the sensor module remains embedded in the tracking label while also being available to a user via a website and/or a reader application deployed on a tablet or a smartphone. The data set can be retained indefinitely, or it can be deleted once it is transmitted externally to the user's reader, or it can be deleted once it is stored in an external physical storage system or in an internet-based storage system. Data that is collected by the tracking label can be transferred via any known wireless communication protocol (including NFC, Bluetooth, etc.).

In further detail, a tracking label as described herein can have a temperature module that measures temperature and conveys data pertaining thereto to the storage module and the transmission module of the tracking label. Other sensor modules can be included as part of the tracking label, to capture, for example, ownership history, winery information, and longitudinal growing conditions for the vintage that the bottle contains, and other parameters such as humidity, light intensity, geographic location, and the like, can be measured by appropriate sensors.

In an embodiment, relatively static data, such as ownership data and origin of the product can be stored on the tracking label along with a unique identifying number tag for the bottle. Certain of these data, such as ownership information, can be updated by scanning the label, as described in more detail below, while other data, such as product origin, is not able to be altered. In addition to these relatively static data, the tracking label collects information from one or more sensors that actively monitor changing conditions in the bottle or its environment. Data stored locally on the tracking label itself offers convenience to the user, who can retrieve ownership history for example by simply scanning the bottle without having to access the database associated with the label. When bottle ownership is transferred, the ownership history contained in the tracking label can be checked against the database to verify its integrity. As would be understood by those of skill in the art, an ownership parameter can contain data pertaining to who owns the bottle bearing the tracking label, while a possession parameter can contain data pertaining to who is charged with the custody of the bottle. While the bottle is in transit from one facility to another, for example, the ownership parameter can be unchanged while the possession parameter can change as the bottle is handed off from the common carrier (for example) to the storage facility or warehouse. A bottle that is sold while remaining at a single location can have its ownership parameter change, while the possession parameter remains unchanged as the bottle remains in the care of the same warehouse or custodian. Under other circumstances, a location parameter can change as a bottle is removed from one location to another, while the ownership and the possession parameters remain the same.

In an illustrative embodiment, a tracking label can comprise a temperature module and additional environmental sensors such as a digital hygrometer (humidity) and a photodetector (light intensity). For sensors requiring exposure to external light conditions such as a photodetector, the overlying identifying label can be perforated over the sensor so that it can be exposed to light. In the description that follows, it is envisioned that all data modules of the tracking label system are contained within a single tracking label; however, as would be understood by skilled artisans, the various modules can be arranged on one or more labels so that their profile or dimensions suit the configuration of the identifying labels, with communication between or among the modules to be provided by near-field communication or other conventional protocols, e.g., Bluetooth-enabled devices for intercommunication. In an embodiment, a primary tracking label, affixed for example to the back of the bottle, can provide for the primary data collection and storage, while a secondary set of data collection sensors can be attached under the front label to retain information about the specific vintage, winery, growing conditions, ratings, and the like.

In embodiments, other features dimensionally adapted for incorporation into the tracking label can be added in order to evaluate conditions that can affect the integrity of the bottle's contents. For example, an accelerometer can be used to identify positional change to the bottles, which could damage the bottles or the contents. As would be understood by artisans in the field, wine bottles may be best stored on their sides so that the corks are kept wet; an accelerometer affixed to the bottle can measure a bottle's orientation during storage. Desirably, an accelerometer can be responsive in three dimensions, so that positional changes on the x, y, or z axis can be ascertained.

As another example, Bluetooth or analogous non-Bluetooth-based locator protocols can be used to determine the location of the wine bottle in space or in reference to another location. Standard Bluetooth location services rely upon the Bluetooth Low Energy radio system to determine whether two Bluetooth-enabled devices are within range of each other, using received signal strength (RSSI) to estimate the proximity of the two devices to each other. In an embodiment, a tracking label can employ a locator system comprising a Bluetooth transmitter (a “tag”) that is programmed to send a signal on a periodic basis to a network of Bluetooth receivers (each, a “locator”) that are positioned at fixed locations throughout a storage facility. Each locator in the network can receive the signal from the tag and estimate the tag's position relative to the locator; the position of the tag then can be estimated by a positioning algorithm employing trilateration, whereby the position of the tag is estimated as a function of the RS SI from the tag as sensed by each of the locators. A trilateration system typically relies on information from three known reference points. A tracking label bearing the tag can thus reveal the position of the wine bottle within the space served by the network of locators. In embodiments, the locator system can be combined with a display to show the position of the wine label within the defined space. In embodiments, the locator system can be combined with a monitoring system that produces a warning signal when a bottle bearing the tag is moved beyond a certain distance. While trilateration-based positioning systems as used with a tag embedded in the tracking label can produce accurate tracking within a 1 to 10 meter range, further precision is available due to improvements in the overall Bluetooth system, as reflected, for example, in version 5.1 of the Bluetooth Core Specification, wherein Bluetooth has added a direction-finding capability that allows a Bluetooth-enabled device to determine the direction of a signal being transmitted from another Bluetooth-enabled device. Using this improved protocol, Bluetooth location systems can use an antenna array that senses a signal's angle of arrival (AoA) or angle of departure (AoD). A tracking label employing the AoA technology can comprise a tag with a single antenna that is capable of transmitting a signal to a receiver having multiple antennas arranged in an array. The transmitted single signal is sensed by each of the multiple antennae, each of which senses a signal phase difference from the others due to the different distances that each receiving antenna has from the transmitting antenna. The receiving device takes samples of the signal while switching among the receiving antennae; the sample data is used to calculate the relative signal direction, and to locate the transmitter more precisely. This AoA-based technology supports real-time locating services (RTLS) down to the centimeter level.

While the Bluetooth system has been described as an example of a real-time locating service suitable for use with the tracking label described herein, it is understood that either Bluetooth or non-Bluetooth-based technologies and protocols that provide relative or absolute positional information can be employed as real-time locating services with an appropriate (Bluetooth or non-Bluetooth-based) transmitter in the tracking label to provide static and dynamic information about the location of the wine bottle in two-dimensional or three-dimensional space. RTLS that interface with a tag in the tracking label can permit functionalities such as: location and management of wine bottles within a facility, thereby preventing misplacement of valuable assets; alerts if a wine bottle is relocated in vertical or horizontal space; time stamping the progress of a wine bottle into and out of a storage facility, or into and out of a controlled temperature facility; theft prevention through asset tracking, alerts, and security activation if a wine bottle is removed from its designated location. In embodiments, the RTLS interfaces with a security system to provide alerts or other data about the location of the wine bottle, or optionally to activate automated security measures to prevent removal of the wine bottle from its designated location. In embodiments, the RTLS includes the transmission of a positional signal from the tracking label indicating its location or position, with the positional signal, having been received by an appropriate data reader optionally networked with an alarm system, is compared with a preselected range of acceptable positions for the tracking label (and hence the wine bottle). In an embodiment, if the positional signal is not within the range of acceptable positions, the data reader sends a notification to the alarm system, which in turn generates an alarm alerting the customer that the tracking label (and hence the wine bottle) is not in its designated position.

In embodiments, the tracking label can interface with a security system. As used herein, the term “security system” refers to any system of interworking components that detects unauthorized interference with the tracking label or the bottle to which it is affixed and produces a response to such detection. Detected interference can include a change in position, a vibrational derangement, a change in temperature, a change in location, or a change in any other parameter that is monitored by the tracking label. Following the detection of such interference, the security system can produce a countervailing response. For example, a security system can respond to the detected unauthorized interference by generating an alarm locally or remotely, or the security system can respond to the detected unauthorized interference by alerting an operator who is charged with monitoring the status of the tracking label or the bottle to which it is affixed. The security system can include a system of closed-circuit cameras that permit visualization of the bottles themselves or their environment. The security system can include automated fences or locks that restrict egress from a specified area in response to a detected interference with the tracker label or the bottle to which it is affixed. The security system can provide automated fire protection, for example by triggering a sprinkler system in response to signals indicating a certain rise in temperature on the tracking label. Other versions of security systems compatible with the tracking label devices, systems, and methods disclosed herein can be readily envisioned by those having ordinary skill in the art.

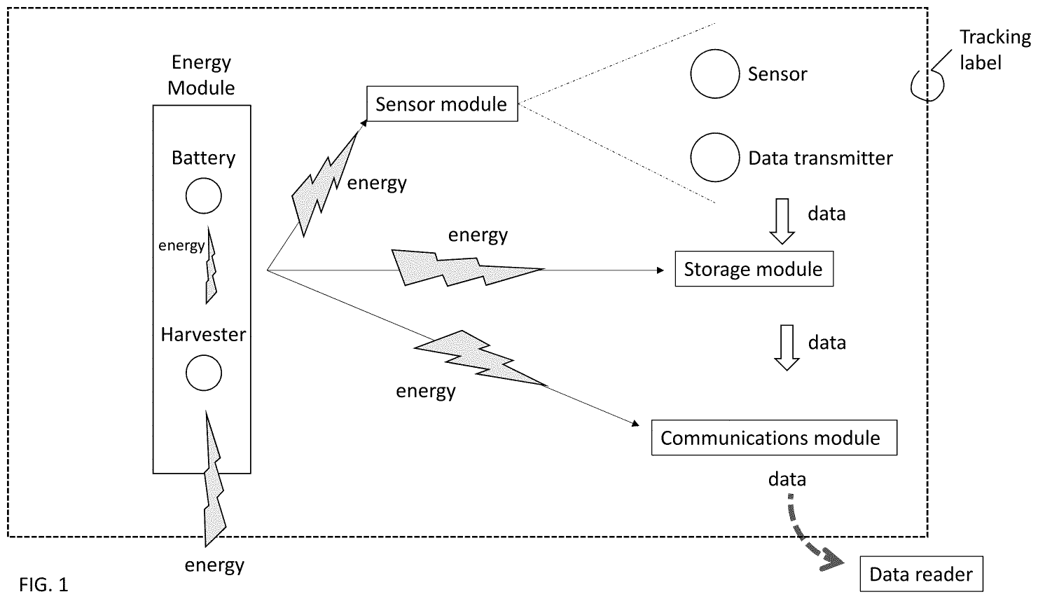

FIG. 1 provides a block diagram of an embodiment of the tracking label. As shown in FIG. 1, the label can include a sensor module, a storage module, and a communications module. The sensor module includes a sensor and a data transmitter. The sensor collects a discrete type of data (e.g., environmental, positional, or intrinsic data), and conveys the data to a data transmitter. Data from the sensor module is stored in a storage module. In series (as shown in FIG. 1) or in parallel (not shown), data from the sensor module is conveyed to a communications module for transmission external to the tracking label, e.g., to a data reader. As further shown in FIG. 1, each of the aforesaid modules is powered by an onboard energy module, where the energy module is incorporated within the one or more tracking labels.

In an embodiment, the sensor in the sensor module records data at fixed intervals. The sensor module receives constant power from the energy module, and the measurement interval can be programmed for the specific tracking label. The measurement interval can be tracked by an internal clock within the sensor module, with this parameter plus other parameters to be transferred to the data transmitter within the sensor module to be conveyed to the storage module. In an embodiment, a fixed measurement interval can be programmed into the tracking label before it is applied to the bottle, while in other embodiments the measurement interval can be adjusted via NFC, Bluetooth-enabled communications systems, or other communication modalities, if necessary, for example if measurements need to be made more frequently to collect more useful data, or if measurements need to be made less frequently to conserve energy.

In an embodiment, the storage module contains flash storage capable of containing records of the sensor module parameters and other bottle-relevant information as such data is captured over the life of the tracking label. In embodiments, the flash storage has a capacity of 1 byte to 100 GB, intended to collect and retain data over the lifetime of the tracking label. If the data accumulated exceeds the capacity of the flash storage, new data can overwrite old data, as would be understood by skilled artisans. It is advantageous for the user to scan the label periodically in order to collect and store data externally, as is described below.

In an embodiment, data is conveyed from the storage module to the communications module, so that it can be transmitted external to the tracking device to a data reader. In embodiments, the communications module comprises a transmitter such as a NFC antenna, enabling it to send data to a NFC-enabled reader such as a smartphone, a tablet, or a dedicated NFC reader; alternatively, the communications module comprises a Bluetooth protocol transmitter, enabling data to be sent to a Bluetooth-enabled data reader such as a smartphone, tablet, or the like. From the external data reader, data can be stored externally (not shown) or transferred to a cloud database. In an embodiment, data successfully transferred to a cloud database can be deleted from the storage module on the tracking label, freeing up more storage space locally for further data collection. Desirably, data can be encrypted, either when transmitted to the storage module, or when transmitted from the storage module to the communications module, or when conveyed externally to the data reader, or when offloaded or uploaded to a storage system (not shown).

In an embodiment, the tracking label modules are powered by an onboard energy module, which can include a rechargeable battery and a RF energy harvester for supplying energy to the rechargeable battery. So configured, the energy module provides energy for the other modules in the system, i.e., the sensor module, the storage module, and the communications module. As shown in FIG. 1, the energy module is integral to the depicted tracking label. In other embodiments, the energy module can be affixed to the bottle separately, provided that energy can be transmitted to the tracking label modules from the energy module conveniently, e.g., wirelessly without requiring too much energy or with inobtrusive wires. The rechargeable battery can be any battery capable of being recharged by direct current, provided that the battery is dimensionally adapted for affixation to or incorporation within the tracing label. In an embodiment, an ultra-thin (<2.0 mm) lithium ion battery can be used. In an illustrative embodiment, the rechargeable battery can be recharged by a radiofrequency (RF) energy harvester that converts ambient radio waves from sources such as cellular communication frequencies (915 MHz), WiFi (2.4 GHz and 5 GHz), and the like, into a direct current. In the absence of sufficient ambient radio waves, the RF energy harvester can be operatively coupled to a plug-in RF energy transmitter which, when connected to a power outlet, will emit RF energy at selected frequencies that are appropriate for the RF energy harvester.

The tracking label depicted schematically in FIG. 1 can be incorporated into a tracking label system that permits data from the tracking label to be stored, distributed, analyzed, and the like. Data obtained from the data reader can be stored in data storage systems external to the tracking label. In embodiments, data obtained from the data reader can also be uploaded to cloud-based data management systems. It is envisioned that the data would be encrypted before uploading, although encryption protocols can be implemented during the uploading process in addition to or as substitutes for any previous encryption.

In an embodiment, uploaded data can be stored on a private permissioned blockchain network allowing connectivity between and among the tracking label (or a plurality of tracking labels) and the wineries using the labels to identify their wine products, and the downstream customers in the product's stream of commerce, including, but not limited to, the distributors transporting, selling, and storing the wine products, and those end-sellers such as auction houses or retail wine stores for whom provenance adds a layer of extra value. For example, a permissioned blockchain network using an open source permissioned blockchain software (e.g., the Linux-based Hyperledger Fabric), can be used. Advantageously, a permissioned blockchain network can safeguard the integrity of and access to data independent of its originator. Moreover, when data is distributed in a blockchain network, no single entity or group of entities can alter or manipulate data, ensuring that integrity is maintained. The tracking label system owner or customer can mediate access to the data stored in the blockchain network, ensuring read-only access for a user requesting the information. Authorized queries can be made through any conventional interface, for example a website or a smartphone app.

In more detail, a blockchain network suitable for interfacing with the tracking label system can comprise a digital ledger distributed between or among multiple parties, wherein each party verifies the validity and accuracy of the ledger's contents. Because the ledger is distributed between or among multiple parties, no single party may alter the contents. In another embodiment, a blockchain network can employ network consensus and/or permissions to validate transactions.

The blockchain network is based on a system of blocks, i.e., groups of transactions that occur within a certain time period. Blocks can be generated in a chronological order, with each block analogous to a page in a written ledger. In an embodiment, the blocks in the blockchain network can each contain a set of transactions within a certain time period, detailing, for example, the ownership transfer of specific bottles of wine. As an example, each transaction can contain an ID address associated with features of the transaction, such as the particular bottle being transferred, the parties involved, and the date and time of transfer. The set of transactions within the block can be “hashed” (encrypted) along with the hashed (encrypted) output of the previous block, thereby linking each block to the previous. In this way, no prior blocks can be altered without changing every subsequent one.

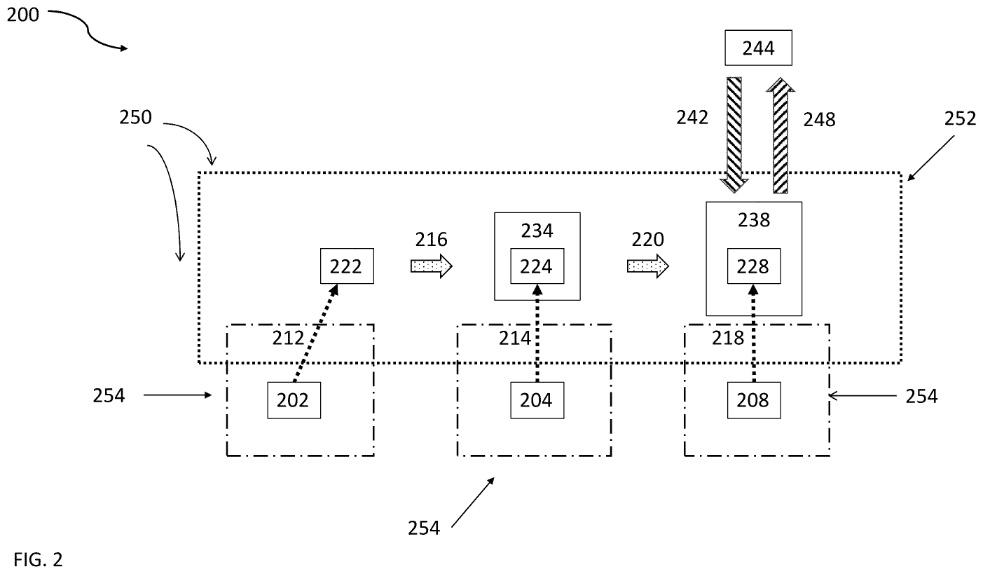

As used with the tracking label, the blockchain network can be permissioned, a term that refers to how transactions within the network are validated. In an embodiment, the permissioned network associated with the tracking label includes only those transactions that are validated by a central network manager responsible for the integrity of the permissioned network, as represented in the block diagram of FIG. 2.

As depicted in FIG. 2, an embodiment of a permissioned network system 200 can include a plurality of unique data sources 202, 204, 208, each providing input 212, 214, 218 to a specific data block 222, 224, 228. In the depicted embodiment, any data input 212, 214, 218 requires validation 250 to be provided, for example, one or more local data management systems 254 granting input access, and/or by a central integrity management system 252 responsible for overall control of information flow. In the depicted embodiment, a discrete data input 212 from a data source 202 is encrypted (not shown) and transmitted 216 to be included with the data block 224 that contains the subsequent data input 214 from another data source 204, thereby creating a data package 234 that includes both the first data input 212 from the first data source 202 and the subsequent data input 214 from the second data source 204, thereby ensuring that any change in the first data block 222 is reflected in the data package 234. In this way, a series of data packages 234, 238, etc., can be created, each of which subsumes a unique data input 214, 218 (respectively) from a unique data source 204, 208 (respectively), along with the cumulative data transmitted (216, 220) from the preceding data package.

Unique data sources can include data derived from tracking label sensors, wineries, and the like. In embodiments, each data package (e.g., 234, 238) is addressable by a query 242 from an authorized user 244, where the query 242 requires permission from the central integrity management system 252 to allow access for the query 242 and data output in response 248. In embodiments, there may be two-factor or multifactor authentication required by the central integrity management system 252 for data input control, for example, for inputting data from a unique data source 202, 204, 208, e.g., a winery, where authorization from the winery and from the tracking label system company would be required. Similarly, for data output in response to queries, the authorized user 244 can be validated with a trust authenticator (not shown), allowing the authorized user 244 to input a query 242 and/or to receive a reply 248. The use of a trust authenticator can permit commercially desirable authorized users 224 such as wineries or other commercial partners (e.g., distributors, auction houses, importers, etc.), to add information to the network, to request information from the network, and to receive information from the network, while preserving the integrity of the data retained therein.

While this invention has been particularly shown and described with references to preferred embodiments thereof, it will be understood by those skilled in the art that various changes in form and details may be made therein without departing from the scope of the invention encompassed by the appended claims.

What is claimed is:

1. A tracking label comprising a sensor module, a receiver system, and an energy module,
the sensor module comprising a sensor for collecting a data set, and a data transceiver that receives the data set from the sensor and transmits the data set to the receiver system,
wherein the receiver system comprises at least one of a storage module and a communications module,
wherein the storage module comprises a flash storage chip capable of storing the data set,
wherein the storage module is further capable of transmitting the data to the communications module,
wherein the communications module comprises a transmitter adapted for transmitting the data set to a data reader positioned external to the tracking label,
and wherein the sensor module and the receiver system are powered by the energy module that comprises a rechargeable battery and a radiofrequency energy harvester, wherein the radiofrequency energy harvester collects energy and transmits it to the rechargeable battery to recharge it periodically.

2. The tracking label of claim 1, wherein the communications module comprises at least one of a real-time locating service transmitter or a tag.

3. The tracking label of claim 1, wherein the transmitter is selected from the group consisting of a near-field communication antenna, a Bluetooth protocol transmitter, and a non-Bluetooth-based transmitter.

4. The tracking label of claim 1, wherein the radiofrequency energy harvester collects energy from ambient radio waves.

5. The tracking label of claim 1, wherein the radiofrequency energy harvester collects energy from radio waves emitted by a radiofrequency energy transmitter.

6. A tracking label system, comprising the tracking label of claim 1, a data reader, and a cloud-based storage system operatively connected to the data reader, wherein the data reader reads a data set produced by the tracking label and the data reader transmits the data set to the cloud-based storage system.

7. The system of claim 6, wherein the tracking label comprises a Bluetooth protocol transmitter, and wherein the data reader is a Bluetooth-enabled device.

8. The system of claim 6, wherein the tracking label comprises at least one of a real-time locating service transmitter or a tag, and wherein the real-time locating service transmitter or the tag interfaces with a real-time locating service adapted for providing information about the location of the tracking label in two-dimensional or three-dimensional space.

9. The system of claim 7, wherein the real-time locating service interfaces with a security system.

10. The system of claim 6, wherein the cloud-based storage system further comprises a cloud-based database.

11. The system of claim 10, wherein the cloud-based database comprises a digitally distributed ledger network.

12. The system of claim 11, wherein the digitally distributed ledger network comprises a blockchain network.

13. The system of claim 12, wherein the blockchain network is selected from the group consisting of a private blockchain network, a permissioned blockchain network, and a private permissioned blockchain network.

14. A method of tracking a parameter pertaining to a wine bottle, comprising:
gathering a data set comprising the parameter using the tracking label of claim 1, storing the data set in a storage module incorporated in the tracking label, gathering the data set from the tracking label via a data reader external to the tracking label, and storing the data set in a storage system, wherein the storage system comprises an internet-based storage network.

15. The method of claim 14, wherein the parameter is a temperature parameter.

16. The method of claim 14, wherein the parameter is selected from the group consisting of a location parameter, an ownership parameter, and a possession parameter.

17. The method of claim 14, wherein the internet-based storage network comprises a blockchain network.

18. The method of claim 14, further comprising a step of sending a signal pertaining to the parameter from a Bluetooth-protocol transmitter incorporated in the tracking label to a Bluetooth-enabled data reader.

19. The method of claim 18, wherein the parameter is a location parameter, wherein the signal is a positional signal, and wherein the positional signal is received by a data reader.

20. The method of claim 19, wherein the data reader is networked with a security system.

21. The method of claim 19, further comprising the steps of (i) comparing the positional signal received by the data reader with a preselected range of acceptable positions, and (ii) sending a notification to the security system if the positional signal is not within the preselected range of acceptable positions.

22. The method of claim 14, further comprising a step of granting a customer read-only access to the data set via a curated interface with the blockchain network.

23. The method of claim 22, wherein the blockchain network is a private permissioned blockchain network.

24. The method of claim 14, further comprising a step of deleting the data set from the storage module after the step of gathering the data or after the step of storing the data.

25. The method of claim 14, further comprising a step of encrypting the data set at any time after the step of gathering the data set.
